(19) United States
(12) Patent Application Publication
(10) Pub. No.: US 2004/0182222 A1
(43) Pub. Date: Sep. 23, 2004

(54) Cymbal stand extension

(76) Inventors: Doris M. Demers, Blackstone, MA (US); Armand Demers, Blackstone, MA (US)

Correspondence Address: LITMAN LAW OFFICES, LTD., P.O. BOX 15035 CRYSTAL CITY STATION, ARLINGTON, VA, 22215, US

(21) Appl. No.: 10/388,396

(22) Filed: Mar. 17, 2003

(51) Int. Cl. G10D 13/02

(52) U.S. Cl. 84/422.3

(57) ABSTRACT

A cymbal stand extension that allows a cymbal stand to support more than one cymbal. The invention consists of a rod, two pads, two washers and one wing nut. The rod is formed with a threaded bolt extending from its top end and an axial bore extending inward from its bottom end. The threaded bolt serves as a mounting bolt for an additional cymbal. The axial bore is internally threaded and mates to the mounting bolt of a standard cymbal stand. Together, the pads, washers and wing nut secure the cymbal to the invention's mounting bolt.

### BACKGROUND OF THE INVENTION

1. Field of the Invention

The present invention relates to percussive musical instruments and, more particularly, to a cymbal stand extension that enables a cymbal stand to support more than one cymbal.

2. Description of the Related Art

To produce percussive sounds, a drummer typically plays on a combination of drums, cymbals and other percussive implements. When preparing for play, the drummer needs to arrange the implements in a manner that will allow him or her to quickly and easily strike each implement. However, due to the amount of space required for each implement and its stand, this is often difficult to accomplish particularly when several cymbals are being used. Furthermore, providing a separate stand for each implement is expensive, requires additional space to transport and store, and requires additional set-up time.

U.S. Pat. No. 6,417,434 to Lao depicts (FIG. 6) a device for mounting an additional cymbal to a standard cymbal stand and thereby allowing multiple cymbals on a single stand. The device includes an adjusting seat and an aspect adjuster both of which allow an additional cymbal to be mounted at an angle different from that of the primary cymbal. However, due its numerous parts, the device is both complex and expensive to manufacture.

Similarly, U.S. Pat. No. 3,893,363 to Cohen claims a kit consisting of mounting bars and rods which connect to a single stand and support multiple bongos, temple blocks, cowbells and cymbals. With respect to mounting multiple cymbals, the kit has at least one notable drawback. It includes a plastic sleeve that must be placed over the stand's mounting bolt. Unfortunately, the plastic sleeve adds to both the complexity and expense of the device.

Additionally, U.S. Pat. No. 5,934,629 to Peritz shows a device that bears a faint structural resemblance to the present invention. The device is a mounting mechanism that supports a cymbal with one magnet that is positioned above another magnet of opposite polarity. Thus, unlike the present invention, the device's support bolt has a uniformed diameter and, hence, does not include a shoulder on which a cymbal can rest. Additionally, like the device of the Cohen patent, the Peritz device includes a sleeve fitted over the threaded portion of the support bolt which, again, adds to both the complexity and expense of the device.

Thus, none of the above inventions or patents, taken either singly or in combination, is seen to describe the instant invention as claimed. Therefore, a cymbal stand extension solving the aforementioned problems is desired.

### SUMMARY OF THE INVENTION

The present invention is a cymbal stand extension that allows a cymbal stand to support more than one cymbal. The invention consists of a rod, two pads, two washers and one wing nut. The rod is formed with a threaded bolt extending from its top end and an axial bore extending inward from its bottom end. The threaded bolt serves as a mounting bolt for an additional cymbal. The axial bore is internally threaded and mates to the mounting bolt of a standard cymbal stand. Together, the pads, washers and wing nut secure the cymbal to the invention's mounting bolt.

The invention is mounted to a standard cymbal stand by securing the axial bore onto the cymbal stand's mounting bolt. When mounted on a cymbal stand, the invention replaces the stand's nut and, thereby, secures the primary cymbal to the cymbal stand's mounting bolt. An additional cymbal is then mounted to the mounting bolt of the invention. The additional cymbal is secured to the invention's mounting bolt by sliding onto the bolt, in the following order, a washer, a pad, the cymbal, a second pad, a second washer, and the wing nut. The additional cymbal is then clamped firmly in place by tightening the wing nut.

An adapter rod is included for situations where the diameter of the axial bore differs from that of the cymbal stand's mounting bolt. One end of the adapter rod attaches to the main rod's axial bore while the opposite end has an axial bore with a diameter that mates to the cymbal stand's mounting bolt. The adapter rod is particularly useful for mounting the invention onto cymbal stands with metric dimensions.

Both the main rod and the adapter rod are constructed of a machined metal. The pads are constructed of a felt material or other soft material. The washers and wing nut are standard sized commercially available items.

The invention allows a drummer to combine two cymbals onto one cymbal stand thereby requiring less set-up space, requiring less space to transport and store equipment, saving time in setting-up equipment, saving the expense of a second cymbal stand, and allowing more musical implements to be located closer to the drummer.

Accordingly, it is a principal object of the invention to combine more than one cymbal onto one cymbal stand thereby eliminating the need for and expense of a second stand.

It is another object of the invention to reduce the amount of set-up space required for a drummer's percussive implements.

It is a further object of the invention to reduce the amount of space necessary to transport and store a drummer's percussive implements.

Still another object of the invention is to reduce the amount of time necessary to set-up a drummer's equipment by reducing the required number of stands.

Additionally, a further object of the invention is to enable a drummer to position more percussive implements closer to his or herself thereby improving his or her drumming speed.

Another object of the invention is to provide a cymbal extension with a minimal number of parts and, specifically, without a mounting bolt sleeve to thereby minimize the complexity of the device and the expense of its manufacture.

Also another object of the invention is to provide a cymbal stand extension that includes one or more adapter rods which allow the device to fit on cymbal stands with varying sized mounting bolts, including mounting bolts with metric dimensions.

Finally, it is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a cymbal stand extension according to the present invention as mounted on a cymbal stand.

FIG. 2 is an exploded perspective view of the invention as shown in FIG. 1.:

FIG. 3 is an elevated front view of a cymbal stand extension with a cymbal mounted thereto and with the cymbal shown in sectional view.

FIG. 4 is an exploded, front perspective view of cymbal stand extension shown with a cymbal.

FIG. 5 is an exploded, front perspective view of the main rod and the adapter rod of a cymbal stand extension.

Similar reference characters denote corresponding features consistently throughout the attached drawings.

### DETAILED DESCRIPTION OF THE PREFERRED EMBODIMENT

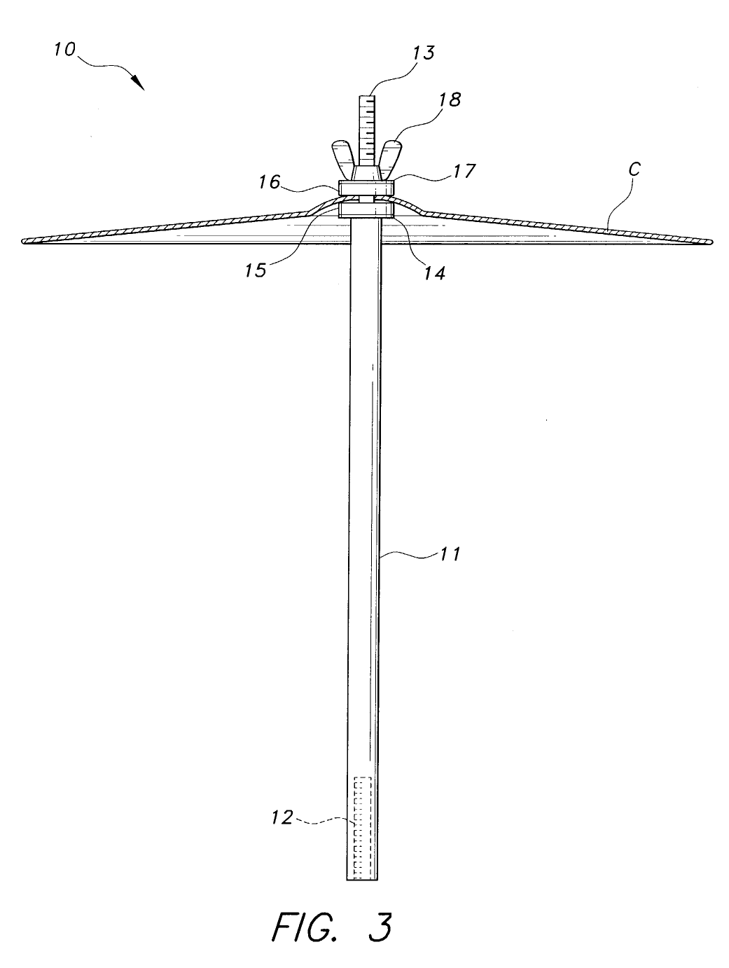

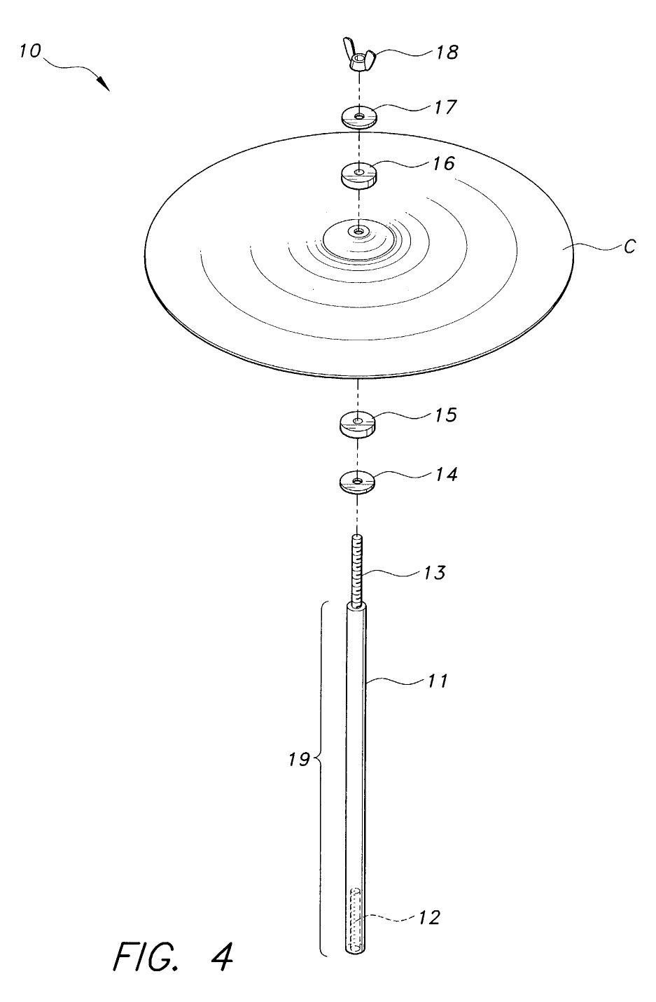

The present invention is a cymbal stand extension designated generally as 10 in the drawings. As shown in FIGS. 3 and 4, the invention consists of a rod 11, two washers 14 and 17, two pads 15 and 16, and a wing nut 18 which together secure an additional cymbal C to a standard cymbal stand.

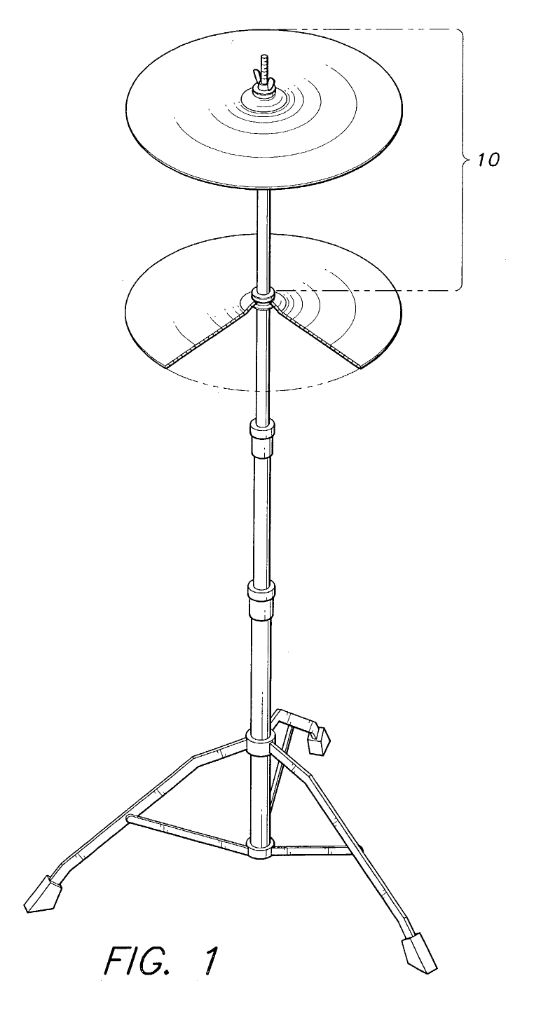

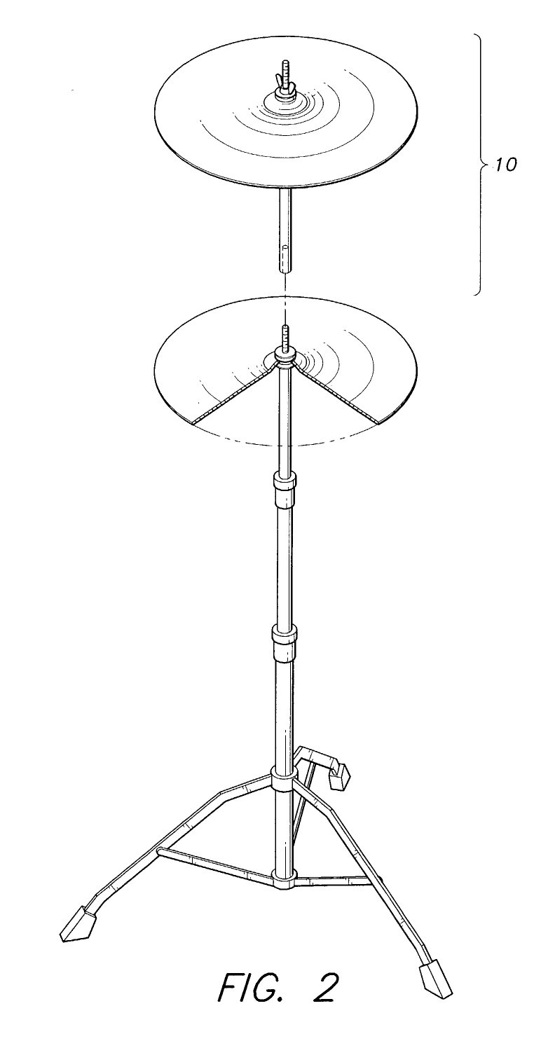

The rod 11 is formed with a threaded bolt 13 extending from one of its ends and an internally threaded axial bore 12 extending inward from the opposite end. The threaded bolt 13 has a smaller diameter than the main body of the rod 19 and is dimensioned to pass through the washers 14 and 17 and pads 15 and 16, and a cymbal C. The main body of the rod 19 will not pass through the washers 14 and 17 and pads 15 and 16 and therefore serves as a support for the washers 14 and 17, pads 15 and 16 and cymbal C. The internally threaded axial bore 12 mates to the mounting bolt of a standard cymbal stand as shown in FIGS. 1 and 2.

The washers 14 and 17 and the wing nut 18 are standard sized commercial available items. Each of the washers 14 and 17 has an aperture through which the threaded bolt 13 will pass. The internal threading of the wing nut mates to the threaded bolt 13.

The pads 15 and 16 are constructed of a felt material to provide a cushioning layer between the cymbal C and each of the washers 14 and 17. Each of the pads 15 and 16 is cylindrical in shape and has an aperture through which the threaded bolt 13 can pass.

A cymbal C is secured to the invention by sequentially sliding onto the threaded bolt the following: a washer 14, a pad 15, the cymbal C, a second pad 16, and a second washer 17. Thereafter, the wing nut 18 is tightened onto the threaded bolt 13 such that the washers 14 and 17, pads 15 and 16, and cymbal C are compressed between the wing nut 18 and the main body of the rod 19.

The rod 11 is secured to a standard cymbal stand by aligning and tightening the internally threaded axial bore 12 with the mounting bolt of the stand. (See FIG. 2).

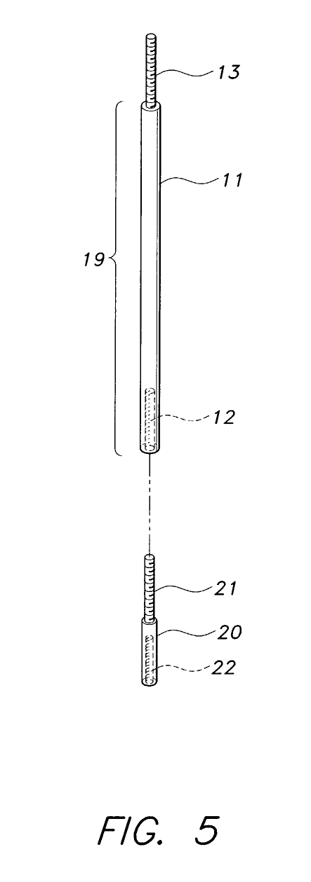

For situations where the invention 10 must be secured to a cymbal stand with a mounting bolt that is of a different size than that of the internally threaded axial bore 12, the invention will include an adapter rod 20, as shown in FIG. 5. The adapter rod 20 is formed with a threaded bolt 21 at one end and an internally threaded axial bore 22 at the opposite end. Its 20 threaded bolt 21 mates to the axial bore 12 of the main rod 11, and its 20 axial bore 22 is sized such that it mates to a non-standard sized mounting bolt, such as a mounting bolt with metric dimensions.

It is to be understood that the present invention is not limited to the embodiment described above, but encompasses any and all embodiments within the scope of the following claims.

We claim:

1. A cymbal stand extension comprising:
a main rod having a first end and a second end;
a threaded bolt extending axially from said first end of said main rod;
an internally threaded axial bore extending inward from said second end of said main rod;
an adapter rod having a first end and a second end;
a threaded bolt extending axially from said first end of said adapter rod; and
an internally threaded axial bore extending inward from said second end of said adapter rod;
wherein said threaded bolt of said adapter rod mates to said internally threaded axial bore of said main rod.

2. The device according to claim 1 wherein:
said main rod is between about 10 and 12 inches in length.

3. The device according to claim 1 wherein:
said threaded bolt of said main rod, said internally threaded axial bore of said main rod, and said threaded bolt of said adapter rod have a diameter of 7.0 millimeters and a thread count of 1.0 threads per millimeter.

4. The device according to claim 3 wherein:
said internally threaded axial bore of said adapter rod has a diameter of 5.0 millimeters and a thread count of 0.8 threads per millimeter.

5. A cymbal stand extension comprising:
a main rod having a first end and a second end;
a threaded bolt extending axially from said first end of said main rod;
an internally threaded axial bore extending inward from said second end of said main rod;
an adapter rod having a first end and a second end;
a threaded bolt extending axially from said first end of said adapter rod;
an internally threaded axial bore extending inward from said second end of said adapter rod;
a first washer and a second washer, a first pad and a second pad, and a threaded nut;
wherein said threaded bolt of said adapter rod mates to said internally threaded axial bore of said main rod;
wherein said first and second pads each have an aperture through which said threaded bolt of said main rod may pass;
wherein said first and said second washers fit onto said threaded bolt of said main rod, and said threaded nut mates to said threaded bolt of said main rod.

6. The device according to claim 5 wherein:
said first and said second pads are constructed of felt material.

7. The device according to claim 5 wherein:
each of said first and said second pads is cylindrical in shape with said aperture axially positioned.

8. The device according to claim 5 wherein:
said main rod is between about 10 and 12 inches in length.

9. The device according to claim 5 wherein:
said threaded bolt of said main rod, said internally threaded axial bore of said main rod, and said threaded bolt of said adapter rod have a diameter of 7.0 millimeters and a thread count of 1.0 threads per millimeter.

10. The device according to claim 9 wherein:
said internally threaded axial bore of said adapter rod has a diameter of 5.0 millimeters and a thread count of 0.8 threads per millimeter.

11. A cymbal stand extension consisting of:
a rod having a first end and a second end;
a threaded bolt extending axially from said first end of said rod;
an internally threaded axial bore extending inward from said second end of said rod;
a first washer and a second washer;
a first pad and a second pad; and
a threaded nut;
wherein said first and second pads each have an aperture through which said threaded bolt may pass;
wherein said first and said second washers fit onto said threaded bolt; and
wherein said threaded nut mates to said threaded bolt.

12. The device according to claim 11 wherein:
said first and said second pads are constructed of felt material.

13. The device according to claim 11 wherein:
each of said first and said second pads is cylindrical in shape with said aperture axially positioned.

14. The device according to claim 11 wherein:
said rod is between about 10 and 12 inches in length.

15. The device according to claim 11 wherein:
said threaded bolt and said internally threaded axial bore have a diameter of 7.0 millimeters and a thread count of 1.0 threads per millimeter.
